(19) United States
(12) Patent Application Publication
(10) Pub. No.: US 2018/0011921 A1
(43) Pub. Date: Jan. 11, 2018

(54) SYSTEM AND METHOD FOR MAPPING DATA FIELDS BETWEEN FLAT FILES AND RELATIONAL DATABASES

(71) Applicant: Paul Barclay, Palatine, IL (US)

(72) Inventor: Paul Barclay, Palatine, IL (US)

(21) Appl. No.: 15/641,296

(22) Filed: Jul. 4, 2017

Related U.S. Application Data
(60) Provisional application No. 62/360,443, filed on Jul. 10, 2016.

(51) Int. Cl. G06F 17/30

(52) U.S. Cl. CPC G06F 17/30598; G06F 17/3053; G06F 17/30091; G06F 17/30123

(57) ABSTRACT

Systems and methods for mapping data fields between flat files and relational databases are disclosed. For example, an operator of a computing system may wish to export select fields from a relational database to a data file. The operator must then manipulate the data file's field header to conform to a defined specification. A computer program may automatically map the fields in that field header to the field names identified in the specification. The program may then rename the fields in the field header to that of the corresponding, specified field names.

### TECHNICAL FIELD

The present disclosure relates in general to databases, and, in particular, systems and methods for mapping fields.

### BACKGROUND

Electronic Discovery involves the exchange of electronic documents and emails between parties pursuant to litigation. The documents and emails are stored in databases, often referred to as document review platforms. Electronic Discovery requires importing and exporting documents between various document review platforms and Electronic Discovery tools. There is no concrete specification for data formats used in the exchange of data between the various document review platforms and Electronic Discovery tools. Therefore, an operator must undertake a time-intensive process of inspecting and manipulating the data for data imports and exports to conform to specifications.

### BRIEF DESCRIPTION OF THE DRAWINGS

The present invention will be understood more fully from the detailed description given below and from the accompanying drawings of various embodiments of the invention, which, however should not be taken to limit the invention to the specific embodiments, but are for explanation and understanding only.

FIG. 1 is a block diagram showing an example system for mapping data fields between flat files and relational databases.

FIG. 2 is a block diagram of an example computing device.

FIG. 3 is a block diagram of example computing devices showing the software components for a field mapping system.

FIG. 4 is a process flowchart showing an example method 400 for mapping data fields between flat files and relational databases.

### DESCRIPTION OF EMBODIMENTS

The following description sets forth numerous specific details such as examples of specific systems, apparatuses, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram formats in order to avoid unnecessarily obscuring the present invention. Thus, the specific details set forth are merely exemplary. Particular implementations may vary from these exemplary details and still be contemplated to be within the spirit and scope of the present invention.

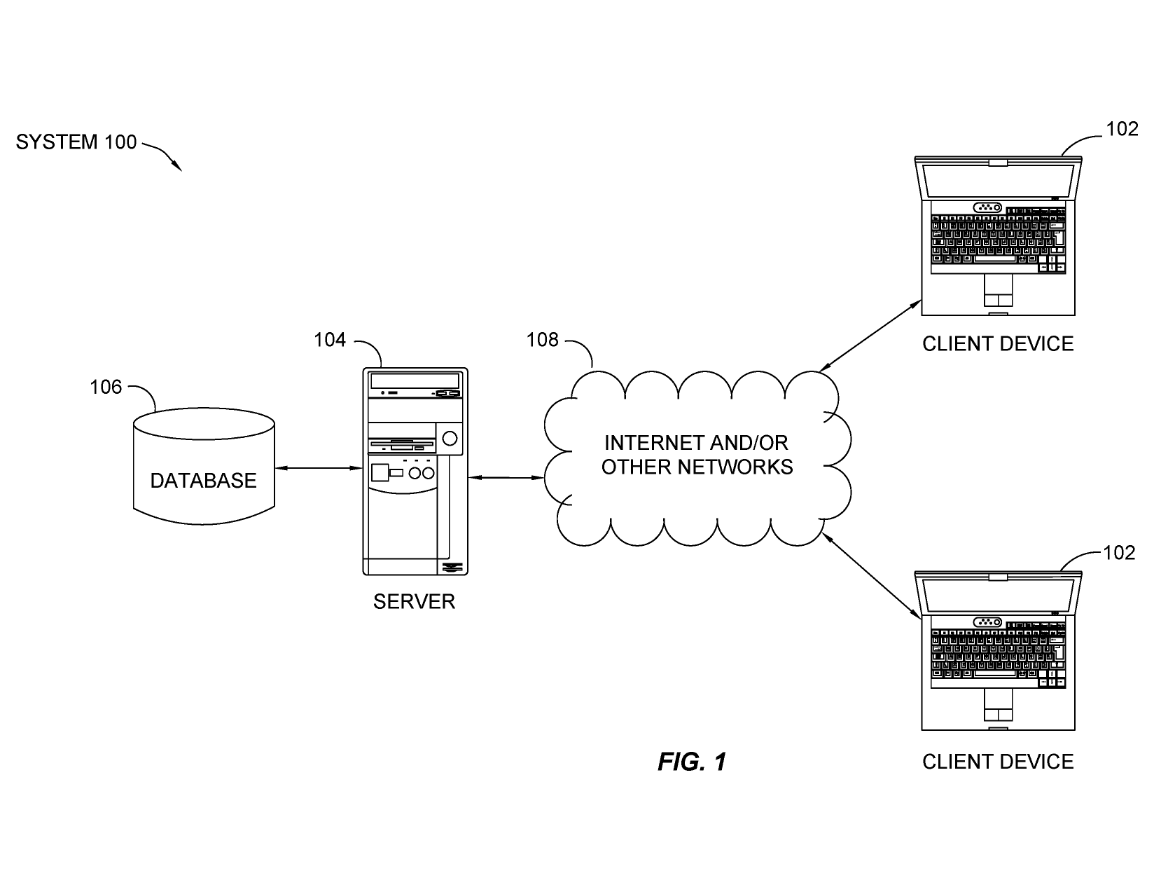

FIG. 1 is a block diagram showing an example system 100 for mapping data fields between flat files and relational databases. The illustrated system 100 includes one or more client devices 102 (e.g., computer, tablet), and one or more databases 106. Each of these devices may communicate with each other via a connection to one or more communication channels 108 such as the Internet or some other wired and/or wireless data network, including, but not limited to, any suitable wide area network or local area network. It will be appreciated that any of the devices described herein may be directly connected to each other instead of over a network.

The server 104 consists of a data repository that store data field names and data field categories in one or more databases 108 for use by the client devices 102 as described in detail below. The database 108 may be connected to the server 104 or directly to the network.

One server 104 may interact with a large number of client devices 102. Therefore, each server 104 is typically a high end computer with a large storage capacity, one or more fast microprocessors, and one or more high speed network connections. In contrast, each client device 102 typically includes less storage capacity, a single microprocessor, and a single network interface.

Each of the devices illustrated in FIG. 1 (e.g., client 102 and/or server 106) may include certain common aspects of many computing devices such as microprocessors, memories, direct memory access units, etc.

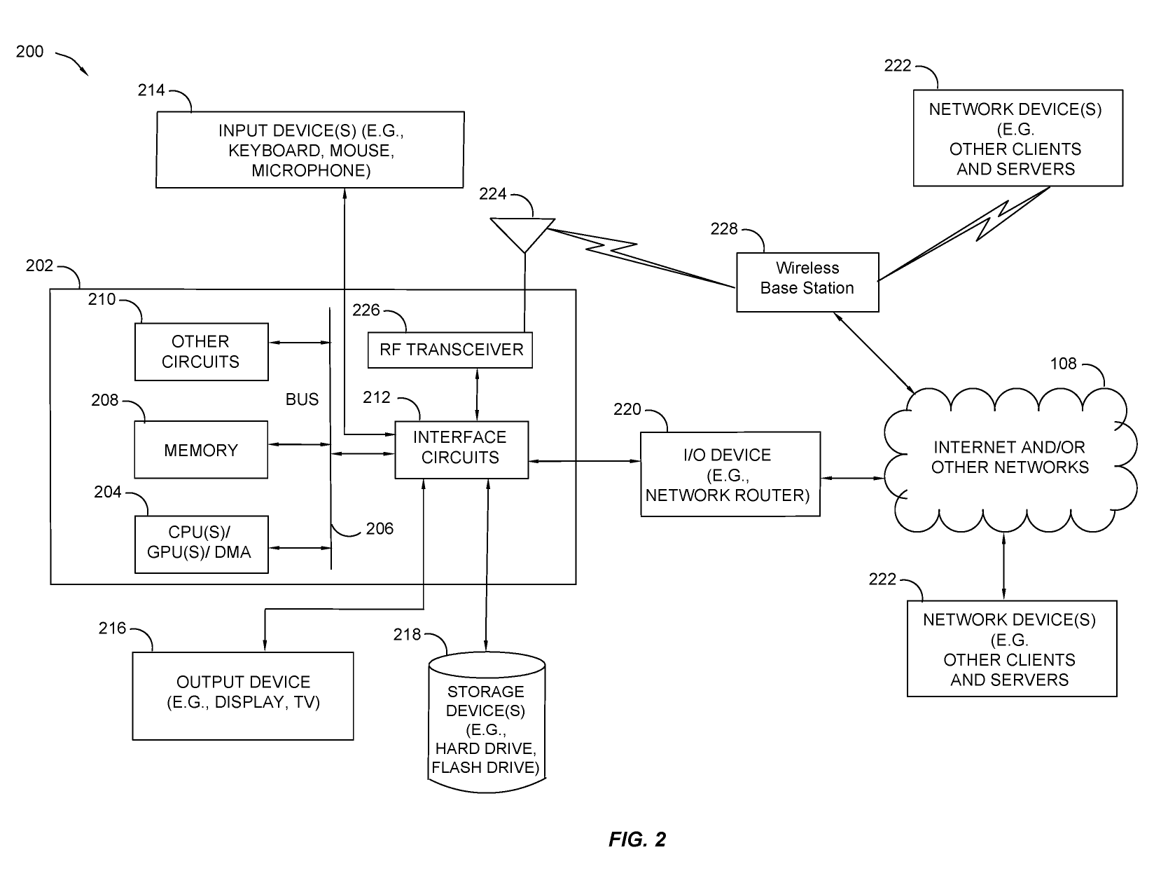

FIG. 2 is a block diagram of an example computing device.

The example computing device 200 includes a main unit 202 which may include, if desired, one or more processing units 204 electrically coupled by an address/data bus 206 to one or more memories 208, other computer circuitry 210, and one or more interface circuits 212.

The processing unit 204 may include any suitable processor or plurality of processors. In addition, the processing unit 204 may include other components that support the one or more processors. For example, the processing unit 204 may include a central processing unit (CPU), a graphics processing unit (GPU), and/or a direct memory access (DMA) unit.

The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processing unit 204 in any suitable manner. The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, voice recognition system, and/or any other suitable input device. One or more displays, printers, speakers, monitors, televisions, high definition televisions, and/or other suitable high bandwidth output devices 216 may also be connected to the main unit 202 via the interface circuit 212. High bandwidth output devices 216 typically consume uncompressed data, such as uncompressed audio and/or video data. For example, a display for displaying decompressed video data may be a cathode ray tube (CRTs), liquid crystal displays (LCDs), electronic ink (e-ink), and/or any other suitable type of display. One or more storage devices 218 may also be connected to the main unit 202 via the interface circuit 212. For example, a hard drive, CD drive, DVD drive, and/or other storage device may be connected to the main unit 202. The storage device 218 may store any type of data used by the device 200. The computing device 200 may also exchange data with one or more low bandwidth input/output (I/O) devices 220. Low bandwidth I/O devices 220 typically produce and/or consume compressed data, such as compressed audio and/or video data. For example, low bandwidth I/O devices 220 may include network routers, thumb drives, and so on. The computing device 200 may also exchange data with other network devices 222 via a connection to a network 108 of FIG. 1. The network connection may be any type of network connection, such as an Ethernet connection, digital subscriber line (DSL), telephone line, coaxial cable, wireless base station 230, etc. Users 114 of the system 100 may be required to register with a server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106. In some embodiments, the device 200 may be a wireless device 200. In such an instance, the device 200 may include one or more antennas 224 connected to one or more radio frequency (RF) transceivers 226. The transceiver 226 may include one or more receivers and one or more transmitters operating on the same and/or different frequencies. For example, the device 200 may include a Bluetooth transceiver 216, a Wi-Fi transceiver 216, and diversity cellular transceivers 216. The transceiver 226 allows the device 200 to exchange signals, such as voice, video and any other suitable data via a base station 228.

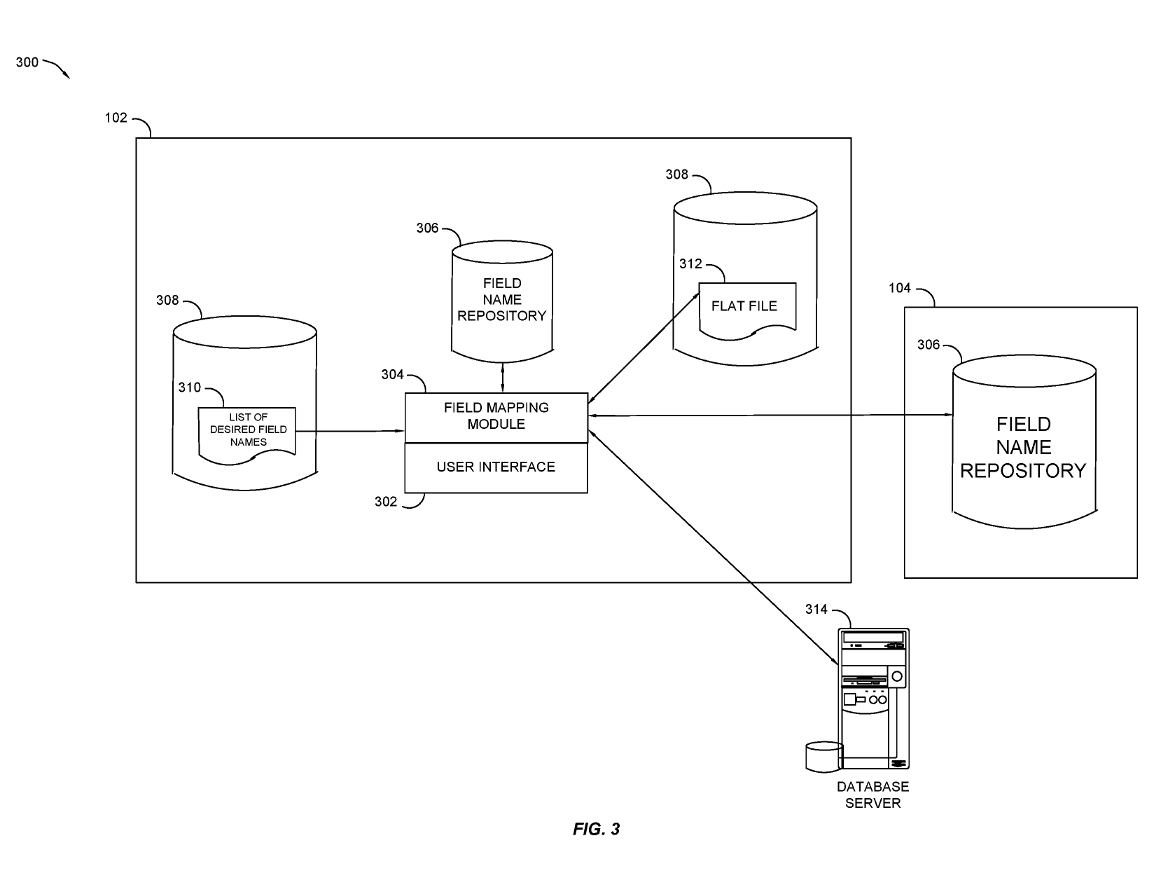

FIG. 3 is a block diagram of example computing devices showing the software components for field mapping system 300 implementing the example client 102 and example server 104 of FIG. 1. The client software includes a user interface 304 and a field mapping module 306. A field name repository 306 is part of the client 102 and/or the server 104.

The user interface 302 receives input from the user and displays the current field map, field mapping status, a list of unmapped fields, user controls (e.g., buttons) for generating and updating the field map, and options for loading, saving, accepting, rejecting, or altering field maps. Via the user interface 302, the user may choose, from storage (e.g., memory or hard drive), a list of desired field names 310 for the final mapping result and one or more flat files 312 as inputs for the field mapping module 304. The list of desired field names 310 may be a file comprising the desired field names. The list of desired field names 310 may be located on the hard drive or located in memory. The flat files 312, defined by a data format (e.g., Concordance-compatible flat file (dat), comma separated values (csv), or binary format), may be a file on the hard drive. The client 102 may also receive the flat files 312 and list of desired field names 310 via an Application Programming Interface (API).

The field name repository 306 stores dictionaries of field names and their categories. For example, in the industry of electronic discovery, such field names may include the metadata captured by electronic discovery tools that represent the date when a particular email was sent. The field name repository 306 may also store the categorization of each of the field names it stores. For example, the field name repository 306 may store email metadata for the date an email was in a flat file 312, that metadata field may be named any of the following “Date Sent”, “Sent Date”, “EmailSentDate”, “DateEmailSent”. Because those fields are named differently, but have essentially the same meaning, the field name repository 306 would have each of those field names categorized under the same category. In this circumstance, the category may be named “Email Sent Date.”

In one embodiment, the field name repository 306 resides only on the client 102. In this instance, the client 102 can generate a field map without the need for a network connection to a server 106. In another embodiment, the field name repository 306 resides only on the server 106. In this instance, a client 102 must have a network connection to server 106 to generate a field map. In yet another embodiment the field name repository 306 resides on both the client 102 and the server 106. In this instance, the client may utilize the field name repository residing on either the client 102 or the server 106 or both.

The field mapping module 304 performs the bulk of the field mapping process and receives input from several sources. These input sources include user decisions via user interface 302, field name repositories 306, the fields comprising the list of desired field names 310, flat files 312, and database servers 314.

The purpose of field mapping module 304 is to map fields between one or more flat files 312 and one or more relational databases located on database servers 314, or between one or more flat files 312 and a list of desired field names 310, or between a list of desired field names 310 and one or more relational databases located on database server 314. When mapping fields between the aforementioned sources, the field mapping module 304 adheres to rules defined by user interface 302 and categories defined in field name repository 306. The process performed by the field mapping module involves categorizing each field from two or more of the aforementioned sources, comparing the resulting categorizations and generating a field map. The field mapping module 304 also creates or updates the flat files 312 utilizing the desired field names in accordance with the mapping results determined by the field mapping module 304 and/or input from the user via the user interface 302. The field mapping module 302 also updates the field name repository 306 with new fields and categories. The field mapping module 302 may also assist, utilizing the resulting field map, with exporting or importing fields and accompanying data from relational databases to or from, respectively, flat files.

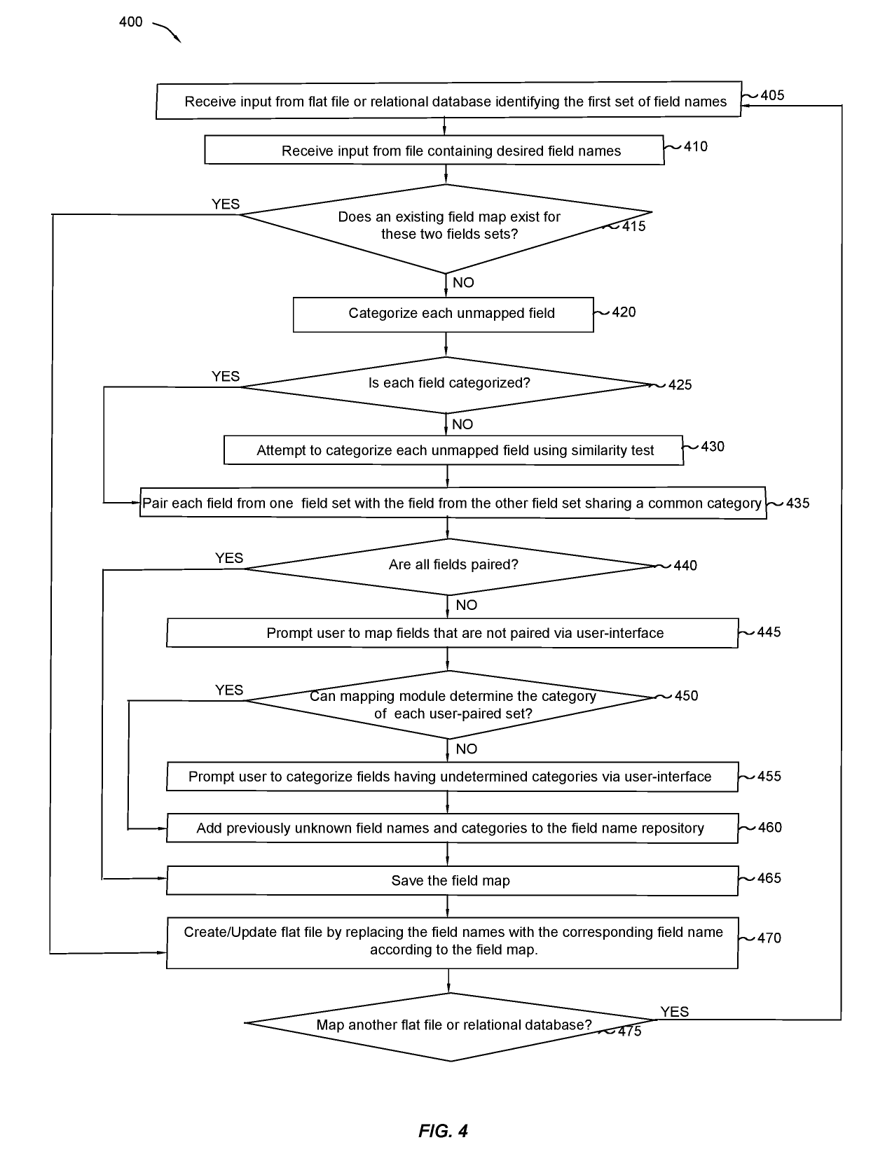

FIG. 4 is a process flowchart showing an example method 400 for mapping data fields between flat files and relational databases in accordance with the present invention. Although the method 400 is described in reference to the flowchart illustrated in FIG. 4, it will be appreciated that many other methods of performing the acts associated with method 400 may be used. For example, the order of many of the operations may be changed, and some of the operations described may be optional. The method 400 starts by receiving input, via the user-interface or an API, from which the process identifies the original field names in a flat file (block 405). The original field names may originate from the first line of a flat file, which typically is the header row, or from a field structure defined in a relational database 314. Next the user's list of desired field names 310 are read as input via the user-interface or an API (block 410). An example of such input is a plaint-text file that lists a plurality of fields, each field delimited by a newline, carriage return, a character, or series of characters. With the goal of mapping fields from the flat file's field set to fields in the desired field set, the field mapping module 304 determines whether a saved field map already exists for the particular sets of fields (block 415). If a saved field map exists, the field mapping module 304 does not need to undergo the process of generating a new field map. However, if a saved field map does not exist, the field mapping module 304, utilizing the field name repository 306, categorizes each unmapped field (block 420). The categorization process entails comparing each field name against fields in the field name repository 303 with the exact same name. When a field with the exact same name is found in the field name repository 303, its category is looked up and that is how the category for a field is determined. Next, field mapping module 304 determines whether each field, in both field sets, has been categorized (block 425). If any field is uncategorized, a similarity test is engaged (block 430). The similarity test may be an algorithm that compares the similarity of 2 strings, given a user-defined or administrator-defined threshold. For example, if a field named “EMAIL_CC” is not found in a field name repository 303, the similarity test may determine that “EMAIL_CC” should be categorized as “Email Carbon Copy” because “EMAIL_CC” is similar enough to “EMAIL CC” which falls under the category “Email Carbon Copy” in the field name repository 303. Next, the field mapping module 304 pairs each field from one field set with the field from the other field set that shares a common category (block 435). Then, the field mapping module determines whether all fields in both fields sets are paired (block 440). There are some situations where a given field may not be paired. For example, a field could be named in such a way that a similarity test finds that the field could fall under more than one category, or a field could be uncategorized because it is not in the field name repository and the similarly test for that particular field failed to find any similarly named fields. Yet another example is multiple fields from one field set that could fall under the same category. Therefore, if at least one field is not paired, the user is prompted via the user-interface to map any fields from the first field set that is not paired with a field from the second field set (block 445). The user interface 302 may provide hints to the user of what the field mapping module 304 believes is the correct pairing in such a way that that the user need only confirm or reject its suggestion. At this stage, the user-interface also presents to the user the tentative field map it has determined for the fields that it has paired. At this stage, the user may adjust any of the field pairings as needed. After the user has mapped fields as needed, the field mapping module 304 can categorize any fields, not located in the field name repository 303, that were mapped by the user (block 450).

If the field mapping module 304 can categorize any fields that were mapped by the user, then the field mapping module 304 may add those fields to their associated categories in the field name repository 303.

If the categories for the fields paired by the user cannot be determined, the field mapping module prompts the user to categorize fields having undefined categories via the user-interface (block 455). Previously unknown field names and categories, that have now been defined by the user, may be added to the field name repository 303 (block 460). Because the field name repository 303 may be located on a server on a local network or the internet, many clients 102 may benefit from access to a field mapping engine that may be updated dynamically as new fields and categories are discovered. To avoid a situation where a field name repository 303 is populated with erroneous field categorization, an administrator may perform a verification or an algorithm may allow an update to the field name repository 303 only when certain conditions are met. After field mapping is complete, the field management system saves the field map (block 465). The field management system updates the flat file 312 by replacing its original field names with the corresponding field names from list of desired field names 310 according to the field map (block 470). The update may be performed several ways including, but not limited to, direct modification of the original flat file or making a copy of the flat file and modifying the copy. Once that is complete, the field mapping module 304 checks whether another flat file is queued to be mapped by the field mapping module (block 475). If yes, the field mapping module starts a new field mapping procedure starting at block 405. This allows for multiple flat files and relational databases, involving substantially the same subject matter, to be mapped in the same mapping session for speed and efficiency.

What is claimed is:

1. A method for mapping data fields between flat files and relational databases, the method comprising the steps of:
Receiving a first list of field names from a relational database;
receiving a second list of field names from a flat file;
determining whether a saved field map exists;
categorizing each field in the first list of field names;
categorizing each field in the second list of field names;
attempting to match each field from the first list of field names to its categorically corresponding field in the second list of field names; and
performing a similarity test on each field name in the first set of field names against each field name in the second set of field names, wherein each pair of fields with the highest similarity ranking while meeting a minimum threshold for similarity are matched.

2. The method according to claim 1, further comprising:
receiving input to reconcile unmatched fields.

3. The method according to claim 1, further comprising:
after completion of the field map, creating a new version of the flat file, wherein the field names therein are renamed to the corresponding field names pursuant to the field map results.

4. The method according to claim 1, further comprising:
after completion of the field map, overwriting the flat file, wherein the field names therein are renamed to the corresponding field names pursuant to the field map results.

5. A system for mapping data fields between flat files and relational databases, the system comprising:
a processor;
a network interface operatively coupled to the processor;
a memory device operatively coupled to the processor, the memory device storing instructions to cause the processor to:
receive a first list of field names from a relational database;
receive a second list of field names from a flat file;
determine whether a saved field map exists;
categorize each field in the first list of field names;
categorize each field in the second list of field names;
attempt to match each field from the first list of field names to its categorically corresponding field in the second list of field names; and
perform a similarity test on each field name in the first set of field names against each field name in the second set of field names, wherein each pair of fields with the highest similarity ranking while meeting a minimum threshold for similarity are matched.

6. The system according to claim 5, wherein the instructions are structured to cause the user interface to prompt the user to reconcile unmatched fields.

7. The system according to claim 5, wherein the instructions are structured to cause the processor to receive input to reconcile unmatched fields.

8. The system according to claim 5, wherein the instructions are structured to cause the processor to, after completion of the field map, create a new version of the flat file, wherein the field names therein are renamed to the corresponding field names pursuant to the field map results.
